(19) United States
(12) Patent Application Publication
(10) Pub. No.: US 2012/0192540 A1
(43) Pub. Date: Aug. 2, 2012

(54) HANDLE ATTACHMENT FOR TOOLS HAVING AN ELONGATED SHAFT

(76) Inventor: Witold S. MACYSZYN, Sussex, NJ (US)

(21) Appl. No.: 13/359,496

(22) Filed: Jan. 27, 2012

Related U.S. Application Data
(60) Provisional application No. 61/462,162, filed on Jan. 31, 2011.

(51) Int. Cl. A01D 7/00; B25G 1/10; A01B 1/02; B25G 1/00

(52) U.S. Cl. 56/400.01; 81/489; 294/57

(57) ABSTRACT

A handle attachment mountable to an elongated shaft of a tool such as a shovel or rake is disclosed. The handle includes a contiguous, elliptical shaped elongated body including a first hook having fastening means configured to removably connect the handle attachment to the elongated shaft, a first elongated section mountable at an acute angle to the shaft, a second elongated section contiguously connected to the first elongated section and configured to mount substantially parallel with the shaft, a third elongated section contiguously connected to the second elongated section, and a second hook contiguously connected to the third elongated section and having a second fastening means configured to removably connect the handle attachment to the elongated shaft. The first and second fastening means are configured to enable lateral and rotational movement about the elongated shaft.

### CROSS REFERENCE TO RELATED APPLICATIONS

This application claims the benefit of U.S. Provisional Application No. 61/462,162 filed on Jan. 27, 2011 which is hereby incorporated herein by reference.

### TECHNICAL FIELD

This disclosure relates to handle attachments, and more particularly to handle attachments for manual tools having elongated shafts.

### BACKGROUND

The statements in this section merely provide background information related to the present disclosure and may not constitute prior art.

Manual tools with elongated handles such as shovels and rakes are commonly used for laborious tasks such as digging and clearing operations of ground or snow. Such tasks can be strenuous and exert severe strain in one's back during operation as many tasks require digging and pushing of the load to be carried out with one's back in a forward bending posture. In particular tasks, considerable back strength is required to lift the soil or snow with a shovel. Stress and exertion of the back to perform such tasks can result in injury or soreness to a user.

Various types of shaft handles and handle attachments are known. In one known type, the upper portion of the shovel handle is bent rearwards at an angle such that the pushing operation may be carried out with one's body in a more upright posture. However, such shovel is adapted for digging as the bent angle does not address back load stresses by requiring a user to bend in a forward posture to move a load.

Another type of handle attachment is disclosed in U.S. Pat. No. 6,485,076 entitled: “Versatile Attachment for a Shovel.” The handle attachment disclosed is affixed at a first point on the shaft enabling the handle to swivel about the point. The handle may be removably affixed to a second point. However, affixing the handle to the second point requires removal and reattachment of components, making state changes time consuming. Further, because the first point is affixed to the shaft, the handle cannot readily move up down the shaft during operation or rotate circularly about the shaft during operation. Further, the ‘V’ shape of the handle disclosed does not optimally alleviate stresses on the back as an upward force cannot be applied at a substantially perpendicular force using the handle attachment.

Another type of handle attachment is disclosed in U.S. Pat. No. 5,331,720 entitled: “Manual Implement Handle Attachment.” The handle attachment disclosed is affixed to both points on a shaft, prohibiting vertical and rotational movement about the shaft. The handle attachment is directed at brushes and mops where users sometimes need to exert a downward force to rub out stains or debris from a floor. Similarly to the reference patent above, the ‘V’ shape of the handle attachment is not directed or adapted to alleviate stress on the back, as the attachment would require a user to pull up at angles substantially changed from a perpendicular force.

Therefore, it would be advantageous to configure a handle attachment to enable users to exert an upward force at a perpendicular angle with respect to the shaft while decreasing a distance one must bend in a forward posture to lift a load, thereby alleviating back stresses.

### SUMMARY

A handle attachment mountable to an elongated shaft of a tool such as a shovel or rake is disclosed. The handle includes a contiguous, elliptical shaped elongated body including a first hook having fastening means configured to removably connect the handle attachment to the elongated shaft, a first elongated section mountable at an acute angle to the shaft, a second elongated section contiguously connected to the first elongated section and configured to mount substantially parallel with the shaft, a third elongated section contiguously connected to the second elongated section, and a second hook contiguously connected to the third elongated section and having a second fastening means configured to removably connect the handle attachment to the elongated shaft. The first and second fastening means are configured to enable lateral and rotational movement about the elongated shaft.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows a handle attachment apparatus, in accordance with the present disclosure;

FIG. 2 shows a side view of the handle attachment apparatus along the A-A line shown in FIG. 1, in accordance with the present disclosure;

FIG. 3 shows the handle attachment apparatus implemented on an exemplary shovel, in accordance with the present disclosure;

FIG. 4 shows the handle attachment apparatus implemented on an exemplary rake, in accordance with the present disclosure

FIGS. 5A and 5B show an embodiment of the fastening means along the A-A line shown in FIG. 1 to hold shafts of varying diameters, in accordance with the present disclosure.

### DETAILED DESCRIPTION

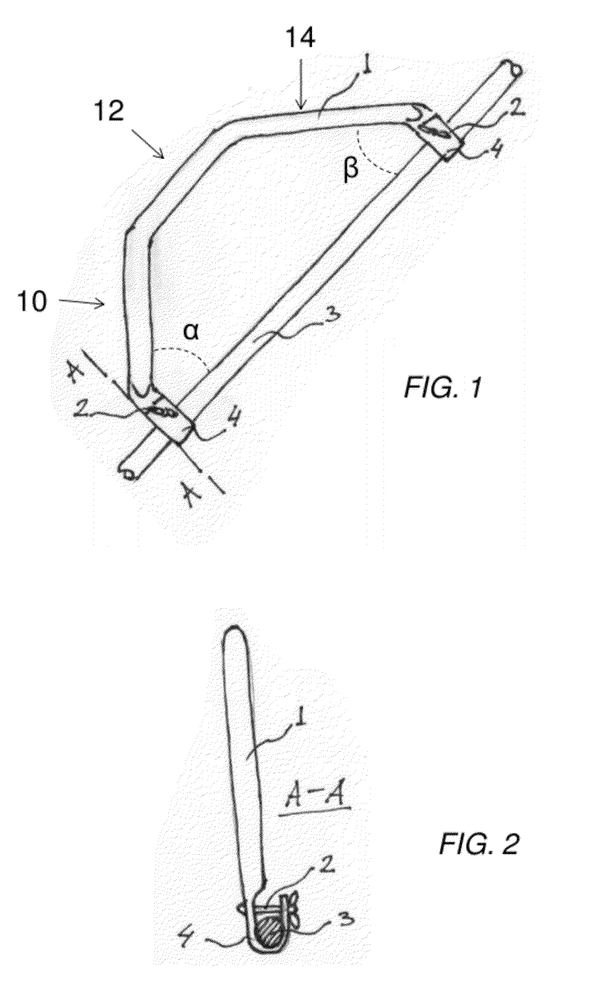

Referring now to the drawings, wherein the depictions are for the purpose of illustrating certain exemplary embodiments only and not for the purpose of limiting the same, FIG. 1 shows a handle attachment apparatus 1 attached to an exemplary shaft 3. The apparatus 1 includes a fastening means 2 and a hook 4. The fastening means 2 is configured to secure the apparatus 1 to an elongated shaft 3 of a manual tool. The hook 4 is preferably a contiguous element of the apparatus 1.

The fastening means 2 is preferably configured to enable easy removal of the apparatus 1 from the shaft 3. The fastening means 2 may be any removable mechanical fastening means such as using a nut and bolt assembly, tapered screws, tacks, staples, stitching, metal clips, snaps, and clamps. In one embodiment, the fastening means is a wing-tipped nut and bolt assembly. In one embodiment, the fastening means loosely secures the apparatus 1 to the shaft 3, enabling the apparatus 1 to slide up and down and from side-to-side along the elongated shaft during use. In this way, the user may preferentially maneuver loads with the manual tool.

The apparatus 1 is formed of a contiguous, elliptical shaped elongated body. A first elongated section 10 is mountable at an acute angle α to the shaft 3. A second elongated section 12 is contiguously connected to the first elongated section 10 and configured to mount substantially parallel with the shaft. A third elongated section 14 is contiguously connected to the second elongated section 12 and is mountable at an acute angle β to the shaft 3. The apparatus 1 is preferably rounded for comfortable gripping. In one embodiment the body of the apparatus is in an elliptical shape. The apparatus 1 is shaped so that a middle section is substantially parallel with the shaft 3. In this way, a user may exert an efficient force upon the shaft 3 to maneuver loads using the manual tool. To position the middle section parallel with the shaft 3, side sections are preferably acutely angled from the shaft 3. The apparatus 1 may be constructed from any number of materials such as metals, e.g., steel, and plastics. In one embodiment, the apparatus is formed from an aluminum tube, having preferential weight and load bearing characteristics that may be adapted for use on a particular manual tool.

FIG. 2 shows a side view of the apparatus 1 including a cross sectional view of the shaft 3. As FIG. 2 shows, the fastening means 2 moveably secures the apparatus 1 to the shaft 3 by compressing the hook 4 around the shaft 3. The fastening means 2 additionally secures the apparatus to the shaft 3 by physically blocking movement of the shaft 3 from the hook 4. The fastening means 2 may be tightened according to user preference or based upon a particular implementation. For example, a user may prefer that the apparatus be fixed when the apparatus is secured to a shovel tool when used to shovel snow. In another example, the user may moveably secure the apparatus 1 so that the apparatus moves laterally when used to maneuver gravel.

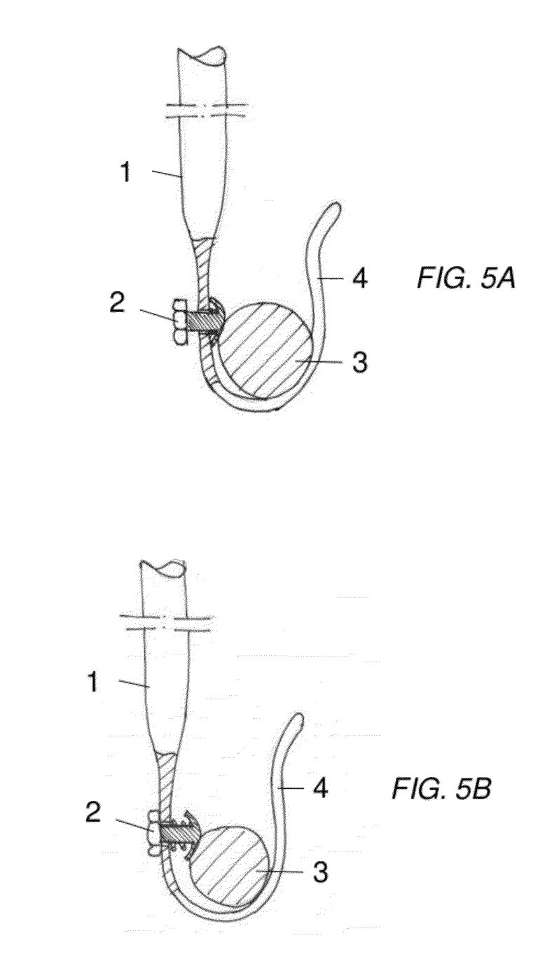

FIGS. 5A and 5B show the apparatus 1 including a screw-based fastening means 2. The screw-based fastening means 2 may include a spring conjured to exert force upon the shaft 3. FIG. 5A shows the screw-based fastening means 2 applied to a shaft having a larger diameter. Force from the screw is applied to the shaft 3 holding the shaft within the hook 4. FIG. 5B shows the screw-based fastening means 2 applied to a shaft 3 having a smaller diameter. The screw is configured to turn into the hook 4 enabling a user to press a screw end against the smaller diameter shaft as desired by the particular application of the apparatus 1.

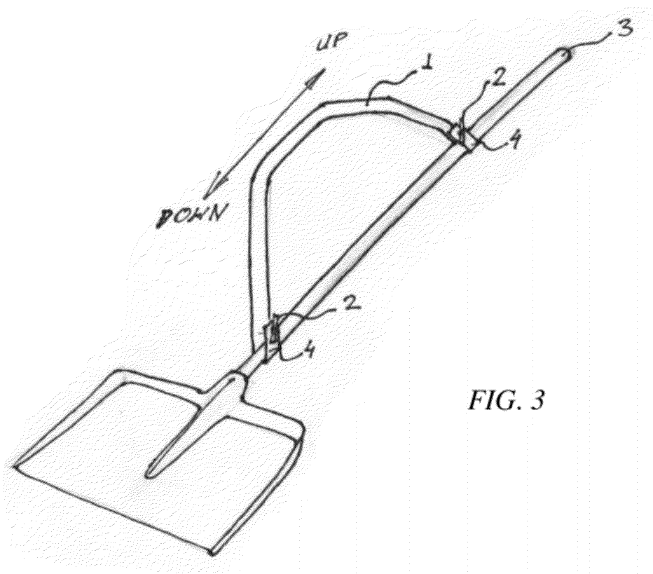

FIG. 3 shows the apparatus 1 moveably attached to an exemplary shovel tool. As FIG. 3 shows, the apparatus 1 may freely move laterally up and down the shaft 3 by the user. Free lateral movement with respect to the shaft 3 permits a user different grip positions from which to maneuver the tool. For example, sliding the apparatus 1 in a downward movement toward the tool end permits a user to focus physical force at a load, while sliding the apparatus toward a distal end of the tool may be preferential when pulling the tool.

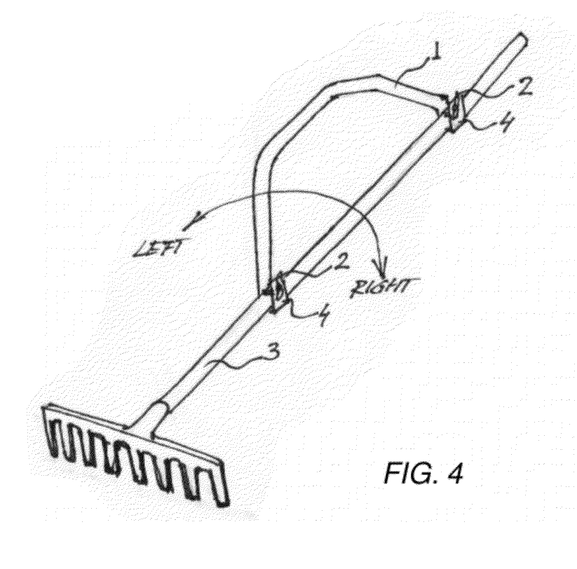

FIG. 4 shows the apparatus 1 moveably attached to an exemplary rake tool. As FIG. 4 shows, the apparatus 1 may freely rotate around the shaft as desired by the user. Free rotation around the shaft enables a user to grip and maneuver the tool in different position as preferred by the user based upon the particular task.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A handle attachment mountable to an elongated shaft of a tool comprising:
a contiguous, elliptical shaped elongated body comprising:
a first hook having fastening means configured to removably connect the handle attachment to the elongated shaft,
a first elongated section mountable at an acute angle to the shaft,
a second elongated section contiguously connected to the first elongated section and configured to mount substantially parallel with the shaft,
a third elongated section contiguously connected to the second elongated section mountable at an acute angle to the shaft, and
a second hook contiguously connected to the third elongated section and having a second fastening means configured to removably connect the handle attachment to the elongated shaft; and
wherein the first and second fastening means are configured to enable lateral and rotational movement about the elongated shaft.

2. The handle attachment of claim 1, wherein the first and second fastening means each comprise a wing-tipped nut and bolt assembly configured to compress each side of the first and second hooks.

3. The handle attachment of claim 1, wherein the first and second fastening means each comprise a spring loaded screw configured to abut the shaft when inserted into the first and second hooks.

4. The handle attachment of claim 1, wherein the body is formed of hollow aluminum.

5. The handle attachment of claim 1, wherein the body is formed of hollow steel.

6. The handle attachment of claim 1, wherein the body is formed of plastic.

7. The handle attachment of claim 1, further comprising a sleeve formed over at least the third elongated section.

8. A handle attachment mountable to an elongated shaft of a tool comprising:
a contiguous, elliptical shaped elongated metal body comprising:
a first hook having a wing-tipped nut and bolt assembly configured to removably connect the handle attachment to the elongated shaft,
a first elongated section mountable at an acute angle to the shaft,
a second elongated section contiguously connected to the first elongated section and configured to mount substantially parallel with the shaft,
a third elongated section contiguously connected to the second elongated section mountable at an acute angle to the shaft, and
a second hook contiguously connected to the third elongated section and having a second wing-tipped nut and bolt assembly configured to removably connect the handle attachment to the elongated shaft; and
wherein the first and second wing-tipped nut and bolt assemblies are configured to enable lateral and rotational movement about the elongated shaft.

9. The handle attachment of claim 8, wherein the metal is aluminum.

10. The handle attachment of claim 8, wherein the metal is steel.

11. The handle attachment of claim 8, wherein the body is hallow.

12. The handle attachment of claim 8, further comprising a sleeve formed over at least the third elongated section.

13. The handle attachment of claim 8, wherein the elongated shaft is connected to a shovel.

14. The handle attachment of claim 8, wherein the elongated shaft is connected to a rake.

15. A handle attachment mountable to an elongated shaft of a tool comprising:
a contiguous, elliptical shaped elongated plastic body comprising:
a first hook having a spring loaded screw assembly configured to removably connect the handle attachment to the elongated shaft,
a first elongated section mountable at an acute angle to the shaft,
a second elongated section contiguously connected to the first elongated section and configured to mount substantially parallel with the shaft,
a third elongated section contiguously connected to the second elongated section mountable at an acute angle to the shaft, and
a second hook contiguously connected to the third elongated section and having a second spring loaded screw assembly configured to removably connect the handle attachment to the elongated shaft; and
wherein the first and second spring loaded screw assemblies are configured to enable lateral and rotational movement about the elongated shaft.

16. The handle attachment of claim 15, further comprising a sleeve formed over at least the third elongated section.

17. The handle attachment of claim 15, wherein the elongated shaft is connected to a shovel.

18. The handle attachment of claim 15, wherein the elongated shaft is connected to a rake.
